(19) United States
(12) Patent Application Publication
(10) Pub. No.: US 2015/0013570 A1
(43) Pub. Date: Jan. 15, 2015

(54) METHOD OF PROCESSING PAINT SLUDGE

(71) Applicant: Resource, Recovery and Recycling, LLC, Rochester Hills, MI (US)

(72) Inventor: Jeffrey J. Bittner, Rochester Hills, MI (US)

(21) Appl. No.: 14/375,097

(22) PCT Filed: Jan. 25, 2013
(86) PCT No.: PCT/US13/23085

§ 371 Date: Jul. 28, 2014

Related U.S. Application Data
(60) Provisional application No. 61/591,432, filed on Jan. 27, 2012.

(51) Int. Cl. C10B 53/00; C08K 3/00; C10B 31/00

(52) U.S. Cl. CPC C10B 53/00; C10B 31/00; C08K 3/0033
USPC 106/405; 201/25

(57) ABSTRACT

In a method of processing paint sludge, measured portions of the sludge are supplied into a heating chamber for pyrolysis at about 1500° F. to disintegrate into organic and inorganic portions, the organic portion in the form of syngas is then drawn out, cooled, and pressurized to be used in kilns or combustion chambers, whereas the inorganic portion in the form of ash is directed to a calciner, where it is heated at about 1500° F. in a controlled presence of oxygen and cooled to have it ready for the reuse in paint manufacturing.

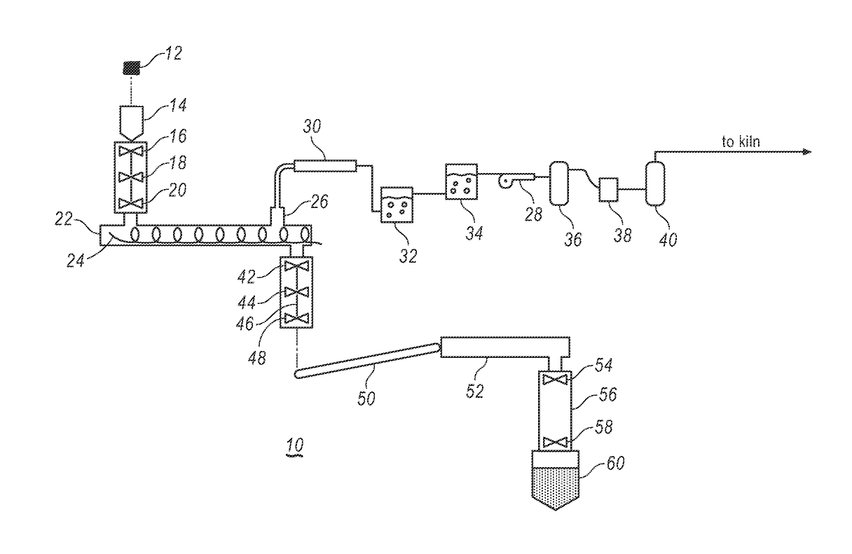

### CROSS-REFERENCE TO RELATED APPLICATIONS

This application claims priority to U.S. Provisional Patent Application No. 61/591,432 filed on Jan. 27, 2012, and International Patent Application No. PCT/US2013/023085, filed on Jan. 25, 2013, both of which are hereby incorporated by reference in their entireties.

### BACKGROUND OF THE INVENTION

1. Field of the Invention

This invention relates to a method and apparatus for the treatment of organic sludges and more particularly to a process for recovery of titanium dioxide and other inorganic materials from paint overspray or scrap paint in a sufficiently pure form so that it may be reused in the formulation and manufacture of new paint.

2. Reference to Related Art

Usually, paint comprises three main components—pigments, binders, and solvents. Pigments include titanium dioxide, which is used to provide opacity, and small amounts of other compounds, both organic and inorganic, which create the color. The binders consist of various polymers and are used to attach the paint to the surface being painted and to hold the pigments in place. The solvents are the fluids, water or other chemicals, which act as a carrier to allow the paint to be sprayed, brushed or otherwise distributed over the surface to be painted. The solvents usually evaporate after the paint is dried to leave a hard dry surface.

When products such as appliances, furniture, automobile bodies and other manufactured goods are painted, the paint is usually applied using a spray applicator. This has the advantage of applying a uniform smooth layer of paint over the full surface of the part being sprayed. At the same time, an overspray is created that misses the part. The overspray is captured in a water curtain creating an aqueous sludge, which is most often gray in color as it is a mixture of a variety of paint colors. It contains a high percentage of titanium dioxide which can be reclaimed from the sludge and sold to the paint manufacturer to be used in paint formulations as a raw ingredient replacement for the virgin titanium dioxide.

Over the years, several patents have been published related to the recycling of paint sludge into a usable raw material. U.S. Pat. No. 5,543,367 issued Aug. 6, 1996 to Chaitanya K. Narula et al., discloses a process for decomposing dried paint sludge to recover the organic and inorganic components of the paint sludge in the form of gaseous, liquid, and composite materials. The process comprises drying the paint sludge to remove water and organic solvents, pyrolizing the dried paint sludge in an inert atmosphere in an elevated temperature of up to about 600° C. to form gaseous and liquid decomposition materials and a solid residue. The process further comprises collecting the gaseous and liquid decomposition materials and subjecting the solid residue to sintering at an elevated temperate of about 900° to 1300° C. in an atmosphere of nitrogen, argon or ammonia to convert the solid residue to composite materials comprising barium titanate and titanium compounds such as titanium dioxide, titanium nitride, and titanium carbide that may be used as reinforcing fillers. The gaseous and liquid materials may be further pyrolyzed to carbon materials.

U.S. Pat. No. 5,087,375 issued Feb. 11, 1992 to Peter Weinwurm discloses a method for handling, treating, heating, and incinerating on-site liquid waste, sewage, sludge, cakes or solid waste. The primary treatment process utilizes a 0.1-50% of plastic clay and may include separation, absorption, precipitation, neutralization, sedimentation, flocculation, coagulation, filtration or dewatering. The residue remaining after the primary treatment is mixed with additional clay or silicates and a suitable absorbent for either organic or inorganic, liquid material, to form a solid mixture of approximately 5-50% clay or silicates and 0.1-10% absorbent. The solidified mixture is formed into granules or other shapes having large surface area. The stable, solid granules are transferred to a conveyorized oven, dried and pyrolized or fired. Resulting organic gases may be condensed to oil, or exhaust gases may be vented into a secondary incineration unit. The resulting product is composed of stable granules, detoxified of organic waste and with all inorganic waste converted into silicate form in which the sludge is mixed with a reagent powder, heated at 350° C. for a sufficient amount of time to yield a residue powder and distilled solvents. The solid residue is only suitable for use as filler in cement or as a reagent to create additional solid residue.

U.S. Pat. No. 5,490,907 issued Feb. 13, 1996 to Peter Weinwurm et al. and related to the '375 patent above discusses a method for the separation and recovery of volatiles from a sludge containing liquid solvents (about 1 to 80% by weight) and solids (20 to 99% by weight), in which said sludge is fed with a reagent powder material in an amount effective to form a mixture having a high surface area to a distillation vessel. The mixture is heated to a temperature up to about 350° C. While the mixture is advanced through the vessel for a time sufficient to distil a sufficient portion of the solvents to yield a solid residue powder, distilled solvents are condensed, and the solid residue powder recovered. The vessel preferably is a mechanical fluidized bed distillation vessel and the mixture is fluidized while being heated therein under a partial vacuum in a non-oxidizing atmosphere. The effective amount of reagent powder material includes about 5 to 70 wt % of the reagent powder material. The solid residue is also suitable only for use as filler in cement or as a reagent to create additional solid residue.

### SUMMARY OF THE INVENTION

There is a need for a process, in which the gasses can be used directly from the process or the solid residue can be used to make additional paint.

The process of the invention converts the organic portion of the paint sludge into a synthetic natural gas that can be supplied directly to a kiln or other heat source to replace coal, oil, natural gas or other fuel. Advantageously, it requires no further treatment because the exhaust from the kiln passes through a scrubber and will remove any unacceptable contaminant. Further in accordance to the process of the invention, the inorganic portion of the sludge is converted into a powder of sufficient purity to be used as a raw material to replace titanium oxide and other pigments in the manufacture of paint.

The method of processing paint sludge according to the present invention provides supplying measured portions of the sludge from a source of sludge into a heating chamber, and subjecting the sludge to pyrolysis in the heating chamber at the temperature of about 1500° F., whereby the sludge is disintegrated into organic and inorganic portions. Then, the organic portion in the form of syngas is drawn from the heating chamber, and the syngas is cooled and pressurized, and thus becomes ready for directing to a consumer, such as kiln.

Alternatively, or concurrently with processing the organic portion, the inorganic portion in the form of ash is directed after the pyrolysis from the heating chamber into a calciner, and is heated there at about 1500° F. for a period of time from several minutes to several hours in a controlled presence of oxygen in the calciner to maintain reducing condition therein, and after cooling the residue becomes ready for the reuse in paint manufacturing.

The measured portions of sludge can be prepared by providing valves before the heating chamber. The valves work in a synchronized cycling mode so that a portion of sludge from the source is allowed between the valves and then into the heating chamber.

A non-reacting gas is injected between the valves to purge oxygen out and prevent syngas from coming in.

The non-reacting gas is injected into the heating chamber during the pyrolysis to maintain oxygen-free environment.

The sludge is preferably moved along the heating chamber during the pyrolysis.

The time of pyrolysis is selected between 15 minutes and several hours depending on quality of the sludge and heating chamber dimensions.

Drawing the syngas from the heating chamber can be performed by creating suction pressure outside the vent.

It is preferable to pass the syngas through a water bath before pressurizing to get rid of contaminants from the syngas.

The ash in the step is directed from the heating chamber into the calciner in a measured manner which is secured by providing valves. They work in a synchronized cycling mode so that a portion of ash from the heating chamber is allowed between the valves and then onto a conveyor to the calciner, the non-reacting gas being injected between the valves.

Cooling the residue after the calciner is performed in a cooling chamber in the presence of the non-reacting gas.

### BRIEF DESCRIPTION OF THE DRAWINGS

These and other features and advantages of the present invention will be clearly understood from the ensuing description and the only accompanying drawing where a schematic flow diagram illustrates the implementation of the method of the invention is presented.

### DETAILED DESCRIPTION OF THE PREFERRED EMBODIMENT

With reference to the flow diagram of the drawing showing a unit 10 for treating paint sludge, the whole process of treating is controlled by a computer (not shown). The paint sludge represented by 12 is being fed into a hopper 14. The sludge does not need to be pre-dried. Going from the hopper 14 is a pipe 15 with three valves. A first gate valve 16 in its open position allows a measured amount of sludge to pass through and drop onto a second gate valve 18, which is closed. By way of example, the measured amount of paint sludge can be about 1 cu ft (30-40 lbs). The gate valve 18 allows the space between the valves 16 and 18 to be pressurized with nitrogen and prevent oxygen from leaking in and displacement of reactor gas (syngas) into the feed hopper 14. For the purpose of this application, terms “nitrogen,” “inert gas,” and “non-reacting gas” are interchangeable.

Further, the first gate valve 16 closes, and the second gate valve 18 opens allowing the measured amount of sludge to drop onto a third gate valve 20, which is closed. The second gate valve 18 closes, and a small amount of nitrogen is injected (not shown) into the space between the valves 18 and 20 to maintain flow upwards during cycling—to purge the oxygen from the space, and downward—to displace syngas. The gate valve 20 then opens to allow the sludge to drop from the pipe 15 into a round heating chamber 22. Thus, the sludge is being fed incrementally as the valves 16, 18, and 20 cycle. The heating chamber 22, where the sludge is separated into organic and inorganic portions, is a horizontal cylinder having the diameter and length sufficient to allow a desired amount of sludge to be treated during a desired period of time. The chamber 22 is heated up to 1,500° F. For heating, a gas fire burner placed between an insulated box (not shown), which the chamber 22 is encapsulated in, and the tube of the chamber can, for example, be used.

Within the heating chamber 22, a screw conveyor 24 carries the sludge forward (from left to right on the drawing) at a predetermine rate towards the opposite (discharge) end of the chamber 22. The conveyor is a conventional screw/auger type conveyor. By way of example, the rate of carrying the sludge is about 1 ft/min in the unit being constructed. Then, the throughput is expected to be at the level of about 3000 lb/hr, but in practice it is scalable and is based on the market demands. The rates are defined by the size and speed of the unit discussed below. The actual rate achieved will be also dependent on qualities of the feed material, and can vary among the sources of material. The conveyor 24 is used to carry the sludge through the chamber 22 because it allows filling most of the chamber space thus not requiring large amounts of nitrogen to maintain an oxygen free environment. The screw conveyor 24 and an inner surface of the heating chamber 22 may be chrome plated to facilitate material flow and prevent the surface from reacting with, or being corroded by, the material being processed. The screw diameter and length of the chamber can vary, respectively, from 5″ in diameter and 10′ in length, as in a pilot system, up to, respectively, 36″ and 20′÷30′ in a larger scale unit. Ultimately, the practical limit will be the size of components that are manageable for assembly and maintenance. The length, diameter, screw pitch, and rotation speed are all variables determining the residence time of material in the reactor vessel (larger vessel and the same speed will result in longer residence times). It is believed that the appropriate space (difference between the diameters of the conveyor and the chamber) is about 3″÷4″. A smaller space can restrict material flow. A larger one may impact quality. By and large, the optimum is dependent on the nature of the raw material used.

Depending on quality of the feed material, its residence time within the chamber 22 can vary from 15 minutes up to several hours. It is the fraction of water and organics in the feed material that will determine the time required to first dry and then pyrolyze the material—those (water content and volatiles content) are the primary quality attributes of the feed that determine required residence times. As the sludge is heated in what is effectively a pyrolysis step—a conversion of solids to gases through increasing the material temperature in the absence of oxygen, -the organic portion of the sludge converts to syngas vented from the chamber 22 through a vent 26. Moderate amount of non-reacting gas introduced into the chamber 22 allow not separating it from the syngas. In this way, the syngas can be used without further treatment, thus increasing its value. A slight vacuum (suction pressure) created by a fan 28 draws the syngas from the chamber through a water jacketed pipe 30 to cool the gas, through a water bath 32 to scrub contaminants from the gas, through a secondary water bath 34, through the fan 28 into a storage tank 36. A compressor 38 pulls the accumulated gas from the storage tank 36 and compresses the gas to about 50 psi in a second storage tank 40. By means of pressure regulated valves (not shown) the compressed syngas is then piped directly to a kiln or other combustion chamber (not shown). There, the syngas is used without further treatment because the kiln or combustion chamber are conventionally equipped with scrubbers and air cleaners to remove any contaminants that may remain after combustion. The process according to the present invention can be potentially self-powered with the syngas.

The inorganic portion of the sludge (in the form of ash, which can comprise metals sought for reusing) is discharged from the bottom of the heating chamber 22 through a first isolation valve 42 onto a second isolation valve 44. The isolation valve 44 opens, and the ash drops therethrough in a chamber 46 filled with a non-interacting gas onto a third isolation valve 48. The isolation valve 44 is then closed. The isolation valve 48 is then opened to allow the ash to drop onto a conveyor 50. The conveyor 50 carries the ash into a calciner 52. The ash is heated up to 1,500° F., and oxygen is introduced (not shown) into the calciner 52 at a controlled rate to maintain reducing conditions in the calciner and allow any carbon residue on the ash to be oxidized and removed from the ash. The residual matter is discharged through a fourth isolation valve 54 into a cooling chamber 56. The valve 54 is closed, and a non-interacting gas is used in the cooling chamber 56 to maintain a controlled, reducing environment. After the matter is cooled, a sixth isolation valve 58 is opened and the inorganic residue, which can be recycled in a paint manufacturing process, is discharged into a container 60 for further shipment to a customer.

Significant differences of the method of the present invention from the prior art methods disclosed in the above-discussed patents include:
1. No reagent material is used in the process of the present invention. The presence of reagent reduces the value and potential use of the ash.
2. The screw conveyor is used in the present invention to eliminate most, if not all, void space in the heating chamber. This minimizes the amount of inert gas used in the process. If the volume of inert gas mixed with the synthetic natural gas is significant, it must be removed from the synthetic natural gas before the syngas can be used. Keeping the inert gas to small amounts allows using the syngas without further treatment, thus increasing the value of the natural gas.
3. The syngas produced according to the present invention is piped directly to a kiln or other combustion chamber which have scrubbers and air treatment systems in place, thus eliminating the need for significant cleaning of the syngas before it can be used. In case of a lime kiln, the syngas would replace coal and provide a cleaner fuel source.
4. According to the present method, the sludge does not need to be pre-dried.
5. According to the present method, the ash can be reused in the manufacture of paint whereas in prior art patents the ash is only suitable as a filler material.
6. Used in the present invention is a two-prong operation in which the gas is bled off as the ash passes through a secondary process in the presence of a controlled amount of oxygen which causes any carbon residue to be oxidized without oxidizing the inorganic ash.

1. A method of processing paint sludge comprising the steps of:
(a) supplying measured portions of the sludge from a source thereof into a heating chamber,
(b) subjecting the sludge to pyrolysis in the heating chamber at the temperature of about 1500° F., to thereby decompose the sludge into organic and inorganic portions,
and further comprising either steps
(c) drawing the organic portion in the form of syngas through a vent of the heating chamber,
(d) cooling the syngas, and
(e) pressurizing the syngas to have it ready for directing to a consumer, such as kiln, or steps
(f) directing the inorganic portion in the form of ash from the heating chamber into a calciner,
(g) heating the ash at about 1500° F. in a controlled presence of oxygen in the calciner to maintain reducing condition therein, and
(h) cooling the residue to have it ready for being reused in paint manufacturing, or comprising the steps (c), (d), (e) and steps (f), (g), (h).

2. The method of claim 1, wherein the measured portions of sludge in the step (a) are prepared by providing valves before the heating chamber, the valves working in a synchronized cycling mode so that a portion of sludge from the source is allowed between the valves and then into the heating chamber.

3. The method of claim 2, wherein a non-reacting gas is injected between the valves.

4. The method of claim 1, wherein a non-reacting gas is injected into the heating chamber during the step (b) to maintain oxygen-free environment.

5. The method of claim 1, further comprising moving the sludge along the heating chamber during the step (b).

6. The method of claim 1, wherein the time of pyrolysis during the step (b) is selected between 15 minutes and several hours depending on quality of the sludge and heating chamber dimensions.

7. The method of claim 1, wherein drawing the syngas in step (c) is provided by creating suction pressure outside the vent.

8. The method of claim 1, further comprising passing the syngas through a water bath between the steps (d) and (e) to thereby remove contaminants from the syngas.

9. The method of claim 1, wherein the ash in the step (f) is directed into the calciner in a measured manner which is secured by providing valves, the valves working in a synchronized cycling mode so that a portion of ash from the heating chamber is allowed between the valves and then onto a conveyor to the calciner.

10. The method of claim 9, wherein a non-reacting gas is injected between the valves.

11. The method of claim 1, wherein cooling during the step (h) is performed in a cooling chamber in the presence of a non-reacting gas.

12. A method of processing paint sludge comprising the steps of:
(i) supplying measured portions of the sludge from a source thereof into a heating chamber,
(j) subjecting the sludge to pyrolysis in the heating chamber at the temperature of about 1500° F., to thereby decompose the sludge into organic and inorganic portions,
(k) drawing the organic portion in the form of syngas through a vent of the heating chamber,
(l) cooling the syngas, and
(m) pressurizing the syngas to have it ready for directing to a consumer, such as a kiln.

13. The method of claim 12, wherein the measured portions of sludge in the step (i) are prepared by providing valves before the heating chamber, the valves working in a synchronized cycling mode so that a portion of sludge from the source is allowed between the valves and then into the heating chamber.

14. The method of claim 12, wherein a non-reacting gas is injected between the valves and into the heating chamber during the step (j) to maintain an oxygen-free environment.

15. The method of claim 12, further comprising moving the sludge along the heating chamber during the step (j).

16. The method of claim 12, wherein the time of pyrolysis during the step (j) is selected between 15 minutes and several hours depending on the quality of the sludge and heating chamber dimensions.

17. A method of processing paint sludge comprising the steps of:
(n) supplying measured portions of the sludge from a source thereof into a heating chamber,
(o) subjecting the sludge to pyrolysis in the heating chamber at the temperature of about 1500° F., to thereby decompose the sludge into organic and inorganic portions,
(p) directing the inorganic portion in the form of ash from the heating chamber into a calciner,
(q) heating the ash at about 1500° F. in a controlled presence of oxygen in the calciner to maintain reducing condition therein, and
(r) cooling the residue to have it ready for being reused in paint manufacturing.

18. The method of claim 17, wherein the ash in the step (p) is directed into the calciner in a measured manner which is secured by providing valves, the valves working in a synchronized cycling mode so that a portion of ash from the heating chamber is allowed between the valves and then onto a conveyor to the calciner.

19. The method of claim 18, wherein a non-reacting gas is injected between the valves.

20. The method of claim 17, wherein cooling during the step (r) is performed in a cooling chamber in the presence of a non-reacting gas.
